(19) United States
(12) Patent Application Publication
(10) Pub. No.: US 2004/0207884 A1
(43) Pub. Date: Oct. 21, 2004

(54) User programmable fax machine to screen unwanted transmissions

(76) Inventor: Steven H. Chen, San Jose, CA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/418,792

(22) Filed: Apr. 18, 2003

(51) Int. Cl. H04N 1/32; H04N 1/00

(52) U.S. Cl. 358/434; 379/93.02; 379/100.05; 358/468

(57) ABSTRACT

In an embodiment of the invention, an apparatus for a user programmable facsimile (fax) machine to screen unwanted transmission, includes: a programmable facsimile (fax) machine configured to receive a programmable code; and a transmitting fax machine configured to send a destination phone number associated with the programmable fax machine across a network; wherein the programmable fax machine establishes communication with the transmitting fax machine if the transmitting fax machine sends the destination phone number across the network and accepts fax data from the transmitting fax machine if the transmitting fax machine sends a code that matches the programmable code. In another embodiment, a method for a user programmable facsimile (fax) machine to screen unwanted transmission, includes: providing, by a destination user, a programmable code to a programmable facsimile (fax) machine; sending, by a transmitting fax machine, a destination phone number associated with the programmable fax machine across a network; and accepting, by the programmable fax machine, fax data from the transmitting fax machine if the transmitting fax machine sends a code that matches the programmable code.

### TECHNICAL FIELD

Embodiments of the present invention relate generally to facsimile machines. More particularly, embodiments of the present invention relate to a user programmable facsimile machine to screen unwanted transmissions.

### BACKGROUND

Currently, all conventional facsimile (FAX) machines accept all incoming fax messages. As a result, current fax machines accept unsolicited or unwanted “junk” faxes such as, for example, telemarketing solicitation fax messages from telemarketers or other parties. These unwanted junk faxes are inconvenient to the recipients, since reading the junk faxes results in a waste of the recipient's time. Also, the junk faxes lead to unnecessary use of important fax machine resources such as, for example, toner, paper supply, and telephone line bandwidth. Furthermore, unwanted junk faxes can be bothersome to the fax recipient.

Therefore, the current technology for fax machines is limited in its capabilities and suffers from at least the above constraints and deficiencies.

### SUMMARY OF EMBODIMENTS OF THE INVENTION

In one embodiment of the invention, an apparatus for a user programmable facsimile (fax) machine to screen unwanted transmission, includes: a programmable facsimile (fax) machine configured to receive a programmable code; and a transmitting fax machine configured to send a destination phone number associated with the programmable fax machine across a network; wherein the programmable fax machine establishes communication with the transmitting fax machine if the transmitting fax machine sends the destination phone number across the network and accepts fax data from the transmitting fax machine if the transmitting fax machine sends a code that matches the programmable code.

The programmable fax machine blocks the call from (and does not accept fax data from)the transmitting fax machine if the transmitting fax machine sends a code that does not match the programmable code or if the transmitting fax machine did not send a code to the programmable fax machine.

In another embodiment, a method for a user programmable facsimile (fax) machine to screen unwanted transmission, includes: providing, by a destination user, a programmable code to a programmable facsimile (fax) machine; sending, by a transmitting fax machine, a destination phone number associated with the programmable fax machine across a network; and accepting, by the programmable fax machine, fax data from the transmitting fax machine if the transmitting fax machine sends a code that matches the programmable code.

These and other features of an embodiment of the present invention will be readily apparent to persons of ordinary skill in the art upon reading the entirety of this disclosure, which includes the accompanying drawings and claims.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram of an apparatus (system) in accordance with an embodiment of the invention.

FIG. 2 is a block diagram illustrating additional details of the apparatus of FIG. 1, in accordance with an embodiment of the invention.

FIG. 3 is a flowchart of a method in accordance with another embodiment of the invention.

### DETAILED DESCRIPTION OF PREFERRED EMBODIMENTS

In the description herein, numerous specific details are provided, such as examples of components and/or methods, to provide a thorough understanding of embodiments of the invention. One skilled in the relevant art will recognize, however, that an embodiment of the invention can be practiced without one or more of the specific details, or with other apparatus, systems, methods, components, materials, parts, and/or the like. In other instances, well-known structures, materials, or operations are not shown or described in detail to avoid obscuring aspects of embodiments the invention.

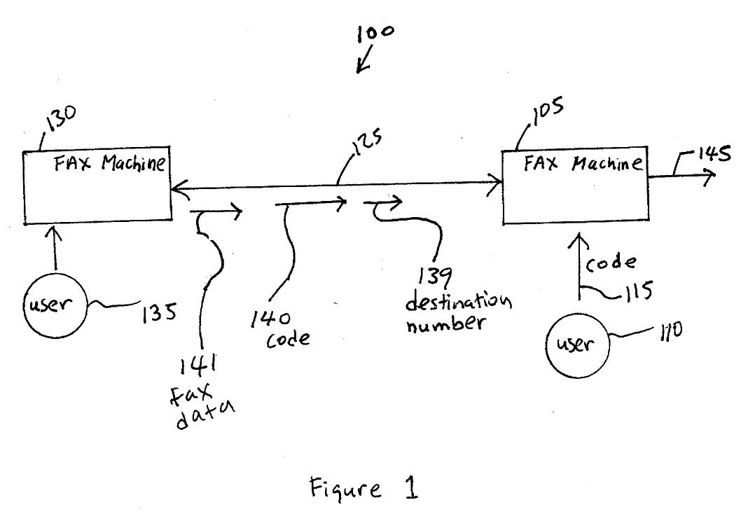

FIG. 1 is a block diagram of an apparatus (or system) 100 in accordance with an embodiment of the invention. The apparatus 100 includes a user programmable destination facsimile (fax) machine 105 that is connected to a network 125, where a user 110 can program a code 115 in the fax machine 105. As described below, the programmed code 115 permits the programmable fax machine 105 to screen fax transmissions from transmitting fax machines such as an originating fax machine 130. The network 125 may be any suitable telecommunications network that permits the fax machines 105 and 130 to communication with each other.

When a sending user 135 wishes to send a fax transmission from an originating fax machine 130 to the destination fax machine 105, the sending user 135 will first input (into the fax machine 130) the destination phone number 139 of the destination fax machine 105. The originating fax machine 130 can establish contact with the destination fax machine 105, by transmitting the destination phone number 139 via network 125 and by use of standard call routing methods that are known to those skilled in the art.

In an embodiment of the invention, after the originating fax machine 130 establishes contact with the destination fax machine 105, the destination fax machine 105 will not accept an incoming fax data 141 from the originating fax machine 130 unless the sending user 135 provides (via fax machine 130) a code 140 that matches a preprogrammed code 115 in the destination fax machine 105. The code 140 is input into the originating fax machine 130 by the sending user 135. The code 140 is then transmitted (via network 125) from the originating fax machine 130 to the destination fax machine 105. If the code 140 from the originating fax machine 130 matches the preprogrammed code 115 in the destination fax machine 105, then destination fax machine 105 will then receive the fax data 141 from the originating fax machine 130 (via network 125) and generate, for example, a printed output 145 that is associated with the fax data 141. It is noted that the printed output 145 is not limited to a printed paper output that contains a text or image that represents the fax data 141. The printed output 145 may alternatively be, for example, a text and/or image (that represents the fax data 141) as displayed on a printer screen.

If the code 140 from the originating fax machine 130 does not match the preprogrammed code 115 in the destination fax machine 105, then the destination fax machine 105 will hang-up to prevent the reception of the fax data 141 from the originating fax machine 130. As a result, since the fax data 141 is prevented from being received by the destination fax machine 105, the printed output 145 of the fax data 141 is not generated, and the user 110 is not disturbed by an unsolicited fax transmission.

Therefore, the programmable fax machine 105 can allow the user 110 to selectively accept a transmitted fax data 141 by use of a preprogrammed code 115. The programmed code 115 prevents the programmable fax machine 105 to receive unwanted or unsolicited fax message transmissions from transmitting fax machines. The code 115 can be, for example, a one-digit, two-digit, or three-digit numerical text (e.g., code “123” or another code with other numerical text value and digit length) that can be input into the programmable fax machine 105. Of course, the code 115 can have numerical text of other digit lengths and values (e.g., code “456710”).

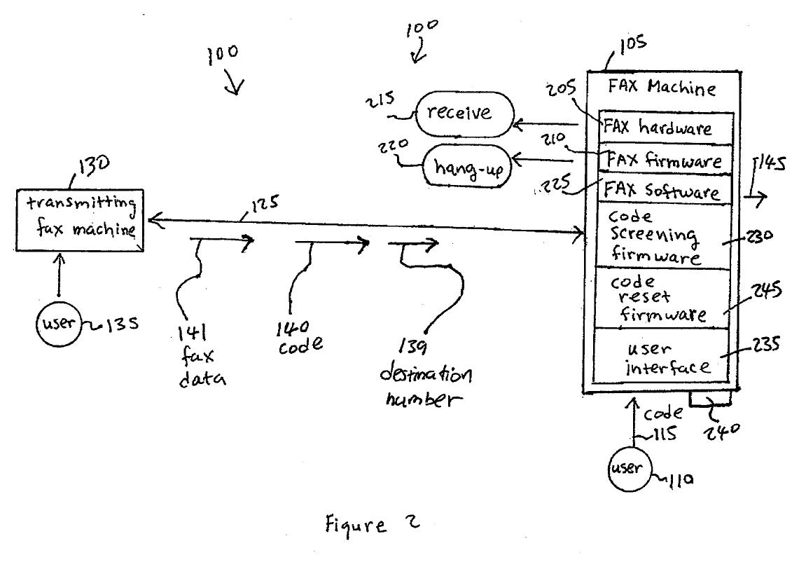

FIG. 2 is a block diagram illustrating additional details of the apparatus 100 of FIG. 1, in accordance with an embodiment of the invention. In an embodiment, the destination programmable fax machine 105 includes a standard fax hardware 205 and standard fax firmware 210. The hardware 205 and firmware 210 perform standard fax machine functions such as, for example, a receiving function 215 to permit a fax transmission data 141 to be received by the programmable fax machine 105 and a hang-up function 220 to permit the programmable fax machine 105 to block or reject a fax transmission data 141 so that, for example, the user 110 is not disturbed by an unsolicited fax transmissions from a transmitting fax machine 130. The fax hardware 205 and fax firmware 210 can also accept the destination phone number 139 that is dialed from the transmitting fax machine 130 so that connectivity is established between the transmitting fax machine 130 and destination fax machine 105. The fax hardware 205 and fax firmware 210 can also generate a printout 145 of any fax data 141 that is received by the fax machine 105.

The firmware 210 is typically stored in a memory that is part of the standard fax hardware 205. The fax hardware 205 and fax firmware 210 may perform other known functions in a fax machine. As known to those skilled in the art, firmware is programming code that is inserted into programmable read-only memory (programmable ROM) or is stored in a ROM, thus becoming a permanent part of a computing device. Firmware is created and tested like software (using microcode simulation). When ready, firmware can be distributed like other software and, using a user interface, installed in the programmable read-only memory by a user. Firmware is sometimes distributed for printers, modems, and other computer devices.

The programmable fax machine 105 may also include standard fax software 225 that provides other standard fax machine functions. The software 225 is also typically stored in memory that is part of the standard fax hardware 205. Other standard components and/or software in the programmable fax machine 105 have been omitted in FIG. 2 for purposes of clarity and for purposes of focusing on the functionalities of embodiments of the invention.

In an embodiment, the programmable fax machine 105 includes code screening firmware 230 that is stored, for example, in memory that is part of the standard fax hardware 205. The destination user 110 may be prompted by a user interface firmware 235 to program (enter) a code 115 that will be used to screen a transmitted fax data 141 from a transmitting fax machine 130. The user 110 can program the code 115 by use of fax interface component 240 which can be, for example, buttons, a touch-screen, or other suitable selection mechanisms or interfaces that permit the user 110 to enter numerical text that will form the code 115.

As an option, a code reset firmware 245 permits the user 110 to reset the programmed code 115. Typically, the code reset firmware 245 can erase the programmed code 115 that has been programmed into the code screening firmware 230 and can permit the user 110 to select a new code 115 to enter via interface component 240 and program into the code screening firmware 230, where the new code 115 is used to screen a transmitted fax data 141 from a transmitting fax machine 130.

It is noted that it is within the scope of embodiments of the invention that at least some of the code screening firmware 230, user interface firmware 235, and code reset firmware 245 can be combined into a single firmware that provides multiple functionalities as described above.

An example operation of the programmable fax machine 105 is now described, in accordance with an embodiment of the invention. The destination user 110 first enters a code 115 formed by numerical text and having a fixed-length in digits (e.g., code “12345”) into the programmable fax machine 105. The user enters the code 115 via the fax interface component 240. The user interface firmware 235 passes the programmed code 115 to the code screening firmware 230 for storage in memory that is part of the fax hardware 205. If, for example, the user 110 decides to change the code 115 value or length, or if the user 110 forgets the programmed code 115, then the user 110 can enter a new code 115 via interface component 240, and the code reset firmware 245 will reset the programmed code 115 in the code screening firmware 230 as the new code 115.

When a sending user 135 wishes to send a fax transmission from the originating fax machine 130 to the destination fax machine 105, the sending user 135 will first input (into the fax machine 130) the destination phone number 139 of the destination fax machine 105. The originating fax machine 130 can establish contact with the destination fax machine 105, by transmitting the destination phone number 139 via network 125 and by use of standard call routing methods that are known to those skilled in the art. The standard fax hardware 205 and standard fax firmware 210 can establish connection with the transmitting fax machine 130 via network 125 after receiving the destination phone number 139 from the transmitting fax machine 130.

In an embodiment of the invention, after the originating fax machine 130 establishes contact with the destination fax machine 105, the code screening firmware 230 in the destination fax machine 105 will not accept an incoming fax data 141 from the originating fax machine 130 unless the sending user 135 provides (via fax machine 130) a code 140 that matches the preprogrammed code 115 in the destination fax machine 105. Therefore, if the code screening firmware 230 detects a code 140 that does not match the programmed code 115, or if the code screening firmware 230 does not detect a code 140 from the transmitting fax machine 130 (because the sending user 135 failed to enter a code into the originating fax machine 130), then the code screening firmware 230 will communicate with the standard fax firmware 210 so that the fax firmware 210 causes the programmable fax machine 105 to hang-up (220) and not accept the incoming call from the transmitting fax machine 130. As a result, the fax data 141 will not be accepted by the fax machine 105 and will not be printed as fax output 145.

On the other hand, if the code screening firmware 230 detects a code 140 that matches the preprogrammed code 115, then the code screening firmware 230 will communicate with the standard fax firmware 210 so that the fax firmware 210 causes the programmable fax machine 105 to receive (215) the fax data 141 and to generate a printout 145 of the fax data 141.

The code screening firmware 230 detects the code 140 from the sender, via touchtone signals from the originating FAX machine 130 and converts these touchtone signals into the corresponding numerical values. The code screening firmware 230 compares the code 140 from the sender 135 with the programmable code (preprogrammed code) 115 as provided by the recipient user 110. The preprogrammed code 115 is stored in the firmware 230, and the firmware 230 is configured to make the comparison of the code 140 and preprogrammed code 115 by use of standard programming techniques.

The code screening firmware 230, code reset firmware 245, and user interface firmware 235 can be set to perform the above described functions by use of standard programming techniques.

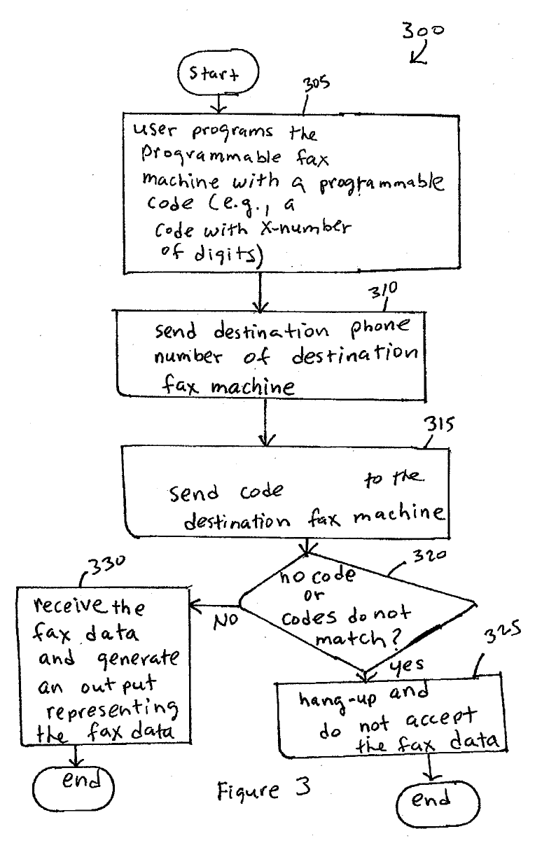

FIG. 3 is a flowchart of a method 300 in accordance with another embodiment of the invention. Initially, the destination user programs (305) a programmable fax machine with a programmable code 115. As an example, the programmable code 115 can be a numerical text with an X-number of digits, where X is any suitable integer value). A sending user then sends (transmits) (310) a destination phone number of the destination fax machine (which is the programmable fax machine with the programmable code 115). The sender may also send (315) a code 140 to the destination fax machine. The sending user sends the destination phone number and code 140 from an originating (transmitting) fax machine. The programmable fax machine compares (320) the code 140 from the sender with the programmable code 115. If the code 140 from the sender does not match the programmable code 115, or if the sender did not send a code 140 (and hence the programmable fax machine did not receive a code 140 from the originating fax machine), then the programmable fax machine hangs up (blocks the incoming call) and does not accept any fax data 141 from the transmitting fax machine, as shown in step (325). On the other hand, if the code 140 from the sender matches the programmable code 115, then the programmable fax machine receives the fax data 141 from the transmitting fax machine and generates a fax output representing the fax data 141, as shown in step (330). The fax output may be, for example, a printout with text and/or images that corresponds to the fax data 141.

The various engines or modules discussed herein may be, for example, software, firmware, commands, data files, programs, code, instructions, or the like, and may also include suitable mechanisms.

Reference throughout this specification to “one embodiment”, “an embodiment”, or “a specific embodiment” means that a particular feature, structure, or characteristic described in connection with the embodiment is included in at least one embodiment of the present invention. Thus, the appearances of the phrases “in one embodiment”, “in an embodiment”, or “in a specific embodiment” in various places throughout this specification are not necessarily all referring to the same embodiment. Furthermore, the particular features, structures, or characteristics may be combined in any suitable manner in one or more embodiments.

Other variations and modifications of the above-described embodiments and methods are possible in light of the foregoing teaching.

Further, at least some of the components of an embodiment of the invention may be implemented by using a programmed general purpose digital computer, by using application specific integrated circuits, programmable logic devices, or field programmable gate arrays, or by using a network of interconnected components and circuits. Connections may be wired, wireless, by modem, and the like.

It will also be appreciated that one or more of the elements depicted in the drawings/figures can also be implemented in a more separated or integrated manner, or even removed or rendered as inoperable in certain cases, as is useful in accordance with a particular application.

It is also within the scope of the present invention to implement a program or code that can be stored in a machine-readable medium to permit a computer to perform any of the methods described above.

Additionally, the signal arrows in the drawings/Figures are considered as exemplary and are not limiting, unless otherwise specifically noted. Furthermore, the term “or” as used in this disclosure is generally intended to mean “and/or” unless otherwise indicated. Combinations of components or actions will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. An apparatus for a user programmable facsimile (fax) machine to screen unwanted transmission, the apparatus comprising:
a programmable facsimile (fax) machine configured to receive a programmable code; and
a transmitting fax machine configured to send a destination phone number associated with the programmable fax machine across a network;
wherein the programmable fax machine establishes communication with the transmitting fax machine if the transmitting fax machine sends the destination phone number across the network and accepts fax data from the transmitting fax machine if the transmitting fax machine sends a code that matches the programmable code.

2. The apparatus of claim 1, wherein the programmable fax machine does not accept fax data from the transmitting fax machine if the transmitting fax machine sends a code that does not match the programmable code.

3. The apparatus of claim 2, wherein the programmable fax machine generates an output associated with the accepted fax data.

4. The apparatus of claim 1, wherein the programmable fax machine does not accept fax data from the transmitting fax machine if the transmitting fax machine does not send a code that matches the programmable code.

5. The apparatus of claim 1, wherein the programmable code is provided by a user.

6. The apparatus of claim 1, wherein the programmable code comprises numerical text.

7. The apparatus of claim 1, wherein the programmable code can be changed to another value.

8. The apparatus of claim 1, wherein the transmitting fax machine sends the code to the programmable fax machine if a sending user provides the code to the transmitting fax machine.

9. A method for a user programmable facsimile (fax) machine to screen unwanted transmission, the method comprising:
providing, by a destination user, a programmable code to a programmable facsimile (fax) machine;
sending, by a transmitting fax machine, a destination phone number associated with the programmable fax machine across a network; and
accepting, by the programmable fax machine, fax data from the transmitting fax machine if the transmitting fax machine sends a code that matches the programmable code.

10. The method of claim 9, further comprising:
generating an output associated with the accepted fax data.

11. The method of claim 9, further comprising:
if the transmitting fax machine sends a code that does not match the programmable code, then blocking the fax data from the transmitting fax machine.

12. The method of claim 9, further comprising:
if the transmitting fax machine does not send a code to the programmable fax machine, then blocking the fax data from the transmitting fax machine.

13. The method of claim 9, wherein the programmable code is provided by a user.

14. The method of claim 9, wherein the programmable code comprises numerical text.

15. The method of claim 9, wherein the programmable code can be changed to another value.

16. The method of claim 9, wherein the transmitting fax machine sends the code to the programmable fax machine if a sending user provides the code to the transmitting fax machine.

17. An apparatus for a user programmable facsimile (fax) machine to screen unwanted transmission, the apparatus comprising:
means for storing a programmable code in a programmable facsimile (fax) machine;
means for sending, by a transmitting fax machine, a destination phone number associated with the programmable fax machine across a network; and
means for accepting, by the programmable fax machine, fax data from the transmitting fax machine if the transmitting fax machine sends a code that matches the programmable code.

18. The apparatus of claim 17, further comprising:
means for generating an output associated with the accepted fax data.

19. The apparatus of claim 17, wherein the means for accepting is configured to block the fax data from the transmitting fax machine if the transmitting fax machine sends a code that does not match the programmable code or if the transmitting fax machine does not send a code to the programmable fax machine.

20. An article of manufacture, comprising:
a machine-readable medium having stored thereon instructions to:
store a programmable code in a programmable facsimile (fax) machine;
receive a destination phone number associated with the programmable fax machine across a network; and
accept, by the programmable fax machine, fax data from a transmitting fax machine if the transmitting fax machine sends a code that matches the programmable code.

21. A method for a user programmable facsimile (fax) machine to screen unwanted transmission, the method comprising:
providing, by a destination user, a programmable code to a programmable facsimile (fax) machine;
receiving, by the programmable fax machine, a destination phone number associated with the programmable fax machine across a network; and
accepting, by the programmable fax machine, fax data from a transmitting fax machine if the transmitting fax machine sends a code that matches the programmable code.

22. The method of claim 21, further comprising:
generating an output associated with the accepted fax data.

23. The method of claim 21, further comprising:
if the transmitting fax machine sends a code that does not match the programmable code, then blocking the fax data from the transmitting fax machine.

24. The method of claim 21, further comprising:
if the transmitting fax machine does not send a code to the programmable fax machine, then blocking the fax data from the transmitting fax machine.

25. The method of claim 21, wherein the programmable code is provided by a user.

26. The method of claim 21, wherein the programmable code comprises numerical text.

27. The method of claim 21, wherein the programmable code can be changed to another value.

28. The method of claim 21, wherein the transmitting fax machine sends the code to the programmable fax machine if a sending user provides the code to the transmitting fax machine.
